(19) United States
(12) Patent Application Publication
(10) Pub. No.: US 2019/0084799 A1
(43) Pub. Date: Mar. 21, 2019

(54) LIGHTING SYSTEMS FOR ELEVATOR SYSTEMS

(71) Applicant: Otis Elevator Company, Farmington, CT (US)

(72) Inventors: Fabien Leze, Neuvy Sur Loire (FR); Erwann Odye, Beaulieu sur Loire (FR); Tony Huron, Saint Martin Sur Ocre (FR); Bruno Beignet, Saint Gondon (FR)

(21) Appl. No.: 16/124,366

(22) Filed: Sep. 7, 2018

(30) Foreign Application Priority Data
Sep. 15, 2017 (EP) 17306190.4

(51) Int. Cl. B66B 5/00; B66B 11/00; B66B 13/28; F21V 33/00; F21V 23/04; F21V 23/00

(52) U.S. Cl. CPC B66B 5/0087; B66B 11/0005; B66B 13/285; F21Y 2115/10; F21V 23/04; F21V 23/001; F21V 33/006

(57) ABSTRACT

Elevator systems having an elevator shaft, a plurality of landings, wherein each landing includes a landing door that enables access from the landing into the elevator shaft, a plurality of guards arranged within the elevator shaft, wherein each landing door includes one of the plurality of guards proximate thereto, and a light element integrated into at least one of the plurality of guards and arranged to project light into the elevator shaft.

### BACKGROUND

The subject matter disclosed herein generally relates to elevator systems and, more particularly, lighting systems for elevator shafts.

Elevator systems include numerous components located within elevator shafts that may require inspection and/or maintenance. To enable proper inspection, lighting must be provided within the elevator shaft. Typically, multiple lights or light modules are fixed every three meters or so (e.g., roughly one for each landing door within the elevator shaft). The light modules may occupy space and require dedicated power supply. Further, such lighting systems may require independent or dedicated inspection, repair, and maintenance performed thereon.

### SUMMARY

According to some embodiments, elevator systems are provided. The elevator systems include an elevator shaft, a plurality of landings, wherein each landing includes a landing door that enables access from the landing into the elevator shaft, a plurality of guards arranged within the elevator shaft, wherein each landing door includes one of the plurality of guards proximate thereto, and a light element integrated into at least one of the plurality of guards and arranged to project light into the elevator shaft.

In addition to one or more of the features described herein, or as an alternative, further embodiments of the elevator systems may include that the light element is an LED light.

In addition to one or more of the features described herein, or as an alternative, further embodiments of the elevator systems may include that the light element is an LED light strip.

In addition to one or more of the features described herein, or as an alternative, further embodiments of the elevator systems may include that the light element is fixedly mounted to the guard.

In addition to one or more of the features described herein, or as an alternative, further embodiments of the elevator systems may include that the guard is a toe guard or apron of the elevator system.

In addition to one or more of the features described herein, or as an alternative, further embodiments of the elevator systems may include that each guard of the plurality of guards includes an integrated light element.

In addition to one or more of the features described herein, or as an alternative, further embodiments of the elevator systems may include a switch and wiring electrically connecting the light element to the switch, wherein the switch operably controls the light element.

In addition to one or more of the features described herein, or as an alternative, further embodiments of the elevator systems may include that the plurality of landing doors are located on a front wall of the elevator shaft, and wherein the wiring extends along the front wall of the elevator shaft.

In addition to one or more of the features described herein, or as an alternative, further embodiments of the elevator systems may include an elevator controller, wherein the light element is operably connected to the elevator controller.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of an elevator system that may employ various embodiments of the present disclosure;

FIG. 2 is a prior art configuration of a lighting arrangement for an elevator shaft;

FIG. 3A is a schematic illustration of an elevator shaft lighting system in accordance with an embodiment of the present disclosure;

FIG. 3B is a schematic view of the an elevator shaft lighting system of FIG. 3A as viewed along the line B-B; and

FIG. 4 is a schematic illustration of an elevator shaft lighting system in accordance with an embodiment of the present disclosure.

### DETAILED DESCRIPTION

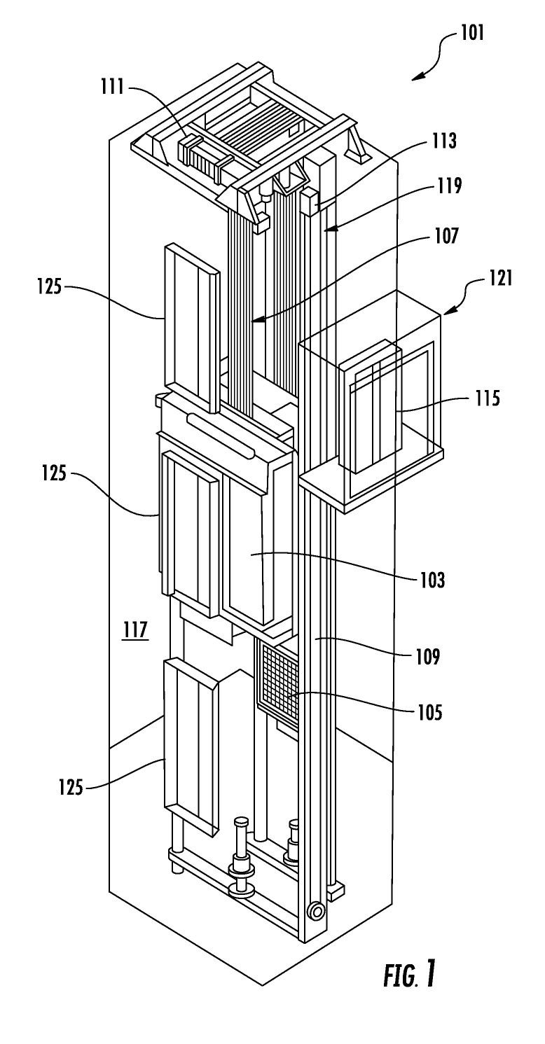

FIG. 1 is a perspective view of an elevator system 101 including an elevator car 103, a counterweight 105, a roping 107, a guide rail 109, a machine 111, a position encoder 113, and a controller 115. The elevator car 103 and counterweight 105 are connected to each other by the roping 107. The roping 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The roping 107 engages the machine 111, which is part of an overhead structure of the elevator system 101. The machine 111 is configured to control movement between the elevator car 103 and the counterweight 105. The position encoder 113 may be mounted on an upper sheave of a speed-governor system 119 and may be configured to provide position signals related to a position of the elevator car 103 within the elevator shaft 117. In other embodiments, the position encoder 113 may be directly mounted to a moving component of the machine 111, or may be located in other positions and/or configurations as known in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position encoder 113. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor.

Although shown and described with a roping system, elevator systems that employ other methods and mechanisms of moving an elevator car within an elevator shaft may employ embodiments of the present disclosure. FIG. 1 is merely a non-limiting example presented for illustrative and explanatory purposes.

At times, various of the components of the elevator system may require inspection and/or maintenance to be performed thereon. For some of the components, visual inspection by a mechanic may be required. When such components are located within an elevator shaft, the mechanic must enter the shaft and be afforded sufficient lighting to make a proper inspection, repair, or other maintenance operation. Embodiments of the present disclosure are directed to improved elevator shaft lighting systems.

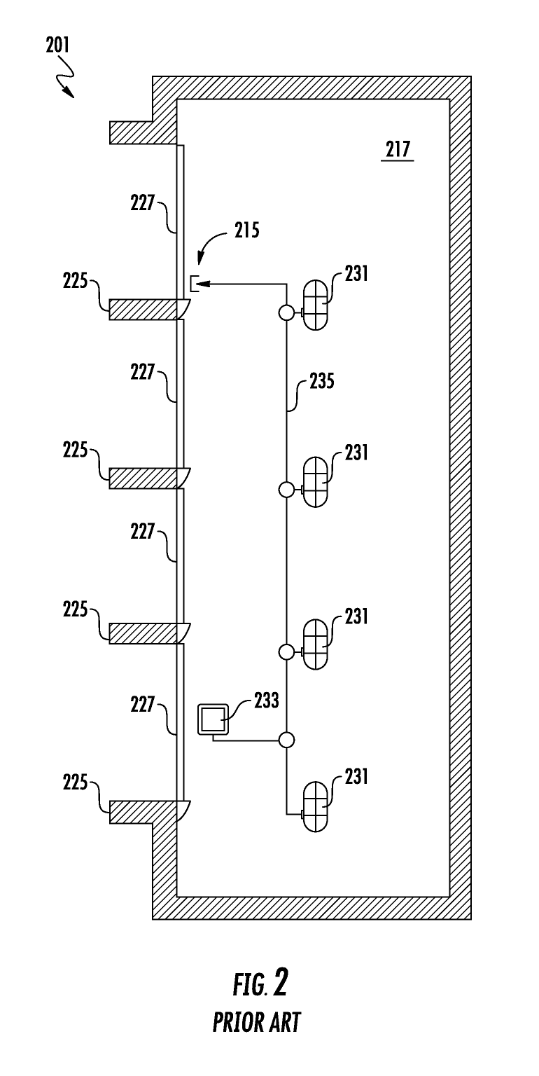

Turning to FIG. 2, a schematic illustration of a prior art configuration of an elevator shaft lighting system is shown. As shown, an elevator system 201 includes an elevator shaft 217 with a plurality of landings 225 each having a respective landing door 227. The landing doors 227 can enable access to the elevator shaft 217 such that a mechanic can perform inspection and/or maintenance within the elevator shaft 217. A plurality of light modules 231 are mounted to a wall of the elevator shaft 217 and are arranged to provide lighting throughout the elevator shaft 217. The light modules 231 are electrically connected to a switch 233 and an elevator controller 215 by wiring 235.

Typically, the light modules 231 are located on a wall of the elevator shaft 217 that does not contain a landing door 227. Such arrangement is used due to operational requirements and components associated with the landing doors 227, e.g., wiring, size and installation requirements of the light modules 231, etc. As such, the light modules 231, and associated power and/or controller elements, can occupy a substantial amount of space within the elevator shaft 217.

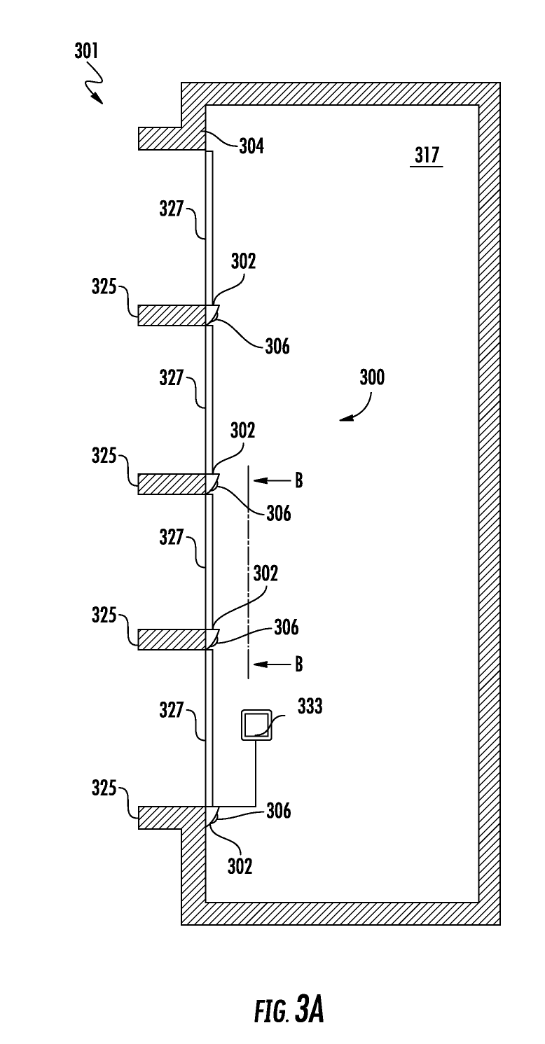

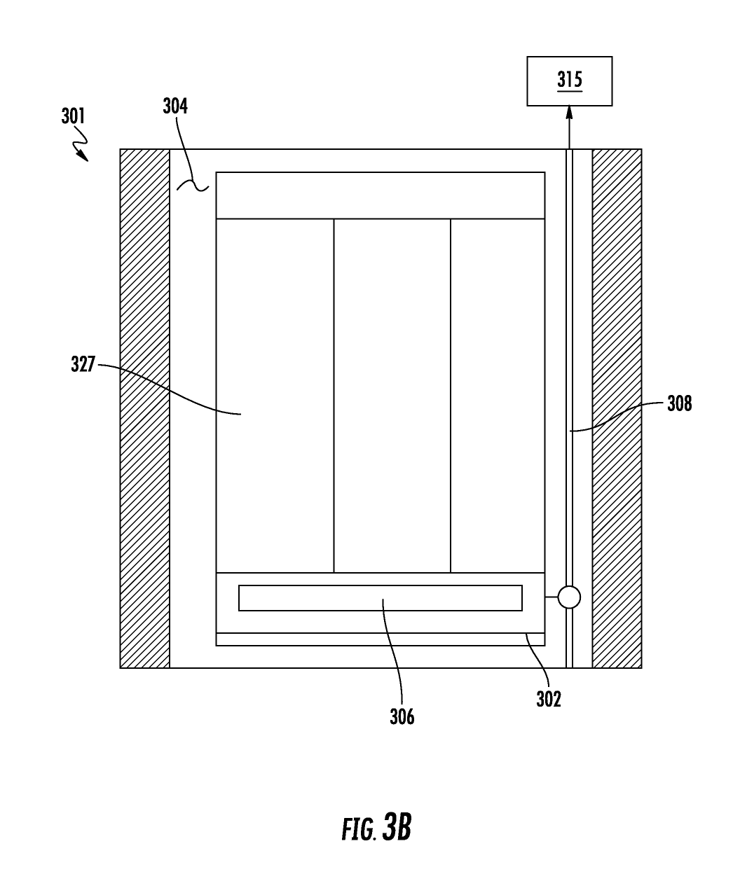

Turning now to FIGS. 3A-3B, schematic illustrations of an elevator shaft lighting system 300 are shown. FIG. 3A illustrates an elevation view of an elevator shaft 317 that incorporates the elevator shaft lighting system 300 and FIG. 3B is an elevation view of a part of the elevator shaft 317 as viewed along the line B-B shown in FIG. 3A. The elevator shaft lighting system 300 is incorporated into an elevator system 301 that includes the elevator shaft 317 and a plurality of landings 325. Each of the landings 325 includes a respective landing door 327. As shown, the landings 325 and landing doors 327 are arranged with respective guards 302.

The guards 302, also referred to as toe guards or aprons, are typically located at the bottom of elevator system doors, such as the landing doors 327. The guards 302 may be arranged to protect passengers from being exposed to the open elevator shaft 317 below an elevator car located at a given landing 325, particularly if the landing doors 327 are opened when the elevator car is not at the landing 325. The guards 302 are downward extensions of a front wall 304, i.e. the wall containing the landing doors 327. The guards 302 typically consist of a plate-like element with a lower part diverging slightly inward into the elevator shaft 317 from the direction of the front wall 304, as will be appreciated by those of skill in the art. Further, in typical guard 302 installations, a supporting structure (not shown) is provided to increase the rigidity of the guard 302, as will be appreciated by those of skill in the art. As noted, the function of the guards 302 is to ensure safe exit of passengers from an elevator car in case the elevator car stops between landing floors 325, e.g., due to a power failure.

In accordance with embodiments of the present disclosure, the elevator shaft lighting system 300 integrates light elements 306 into the guards 302. The light elements 306 can be LED or other types of lights, thus enabling a low profile and ease of integration into the guards 302. The light elements 306 are electrically connected to a switch 333 which may be located within the elevator shaft 317 or at another location. Further, as will be appreciated by those of skill in the art, the light elements 306 can be operably connected to an elevator controller 315 (shown in FIG. 3B).

With reference to FIG. 3B, as shown, the light element 306 is shaped as a bar or strip of lights within the guard 302. The light element 306 is electrically connected to wiring 308 as shown. The wiring 308 is mounted to or extends along the front wall 304. As shown, the wiring 308 operably connects the light element 306 to the elevator controller 315. The elevator controller 315 can be used to activate the light elements 306 (in addition to or alternatively from the switch 333. In some embodiments, the light elements 306 can communicate with and be selectively controlled by the elevator controller 315, such that specific lighting and/or illumination within the elevator shaft 317 can be achieved.

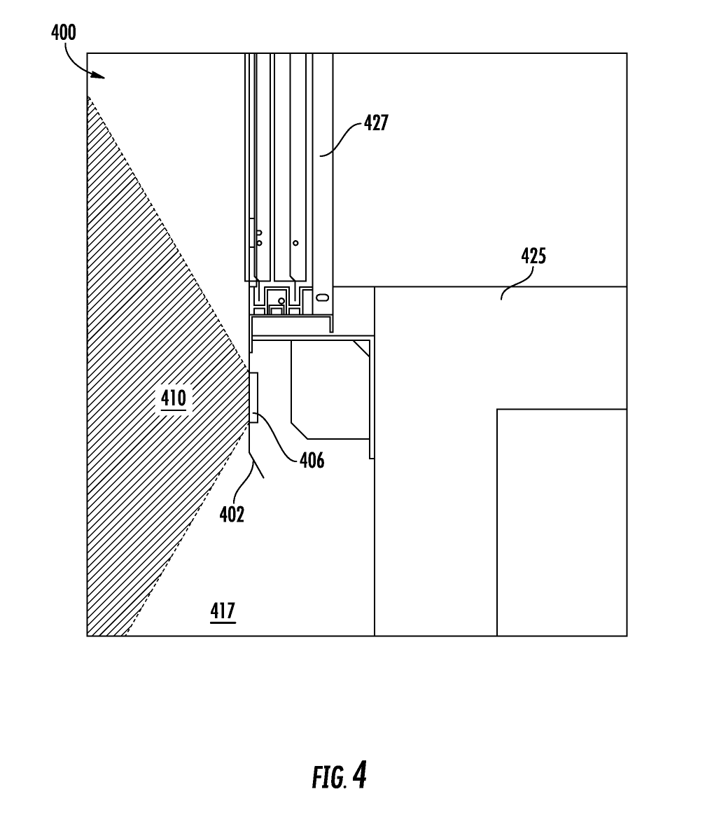

Turning now to FIG. 4, a side view schematic illustration of an elevator shaft lighting system 400 in accordance with an embodiment of the present disclosure is shown. As shown, a side view of a landing 425 with a landing door 427 proximate an elevator shaft 417 is schematically shown. The landing 425 and landing door 427 are part of an elevator system that includes the elevator shaft 417. The landing door 427 is openable onto the elevator shaft 417, but typically only opens when an elevator car is present at the landing door 427. The landing door 427 has a guard 402 extending downward therefrom within the elevator shaft 417.

As shown, the guard 402 includes a light element 406 integrated therewith. The light element 406 is operable and controllable to project light 410 into the elevator shaft 417 and thus provide illumination therein.

The integration of the light element 406 to the guard 402 can be by uniform construction or by fixedly attaching or mounting a lighting structure (e.g., LED light strip) to the material/structure of the guard 402. In some embodiments, the light element 406 may be fixed to a front side of the guard 402 (e.g., to the left side of the guard 402) or may be mounted or fixed to a back side of the guard 402 (as shown in FIG. 4). In some such embodiments, the guard 402 can include a cut-out or window that enables the light 410 from the light element 406 to be projected into the elevator shaft 417. In some embodiments, the light element 406 can be manufactured or assembled with the structure of the guard 402 such that a single unit is delivered and installed within the elevator shaft 417 at the time of installation of the elevator system.

Advantageously, embodiments provided herein are directed to lighting systems for elevator shafts that minimize installation and/or occupied space while also maintaining adequate lighting within an elevator shaft. Further, advantageously, elevator shaft lighting systems of the present disclosure can reduce the space required for lighting within elevator shafts. For example, typical lighting modules can be completely eliminated, and the elevator shaft lighting systems provide for integrating lighting elements into existing elevator system components, such as the guards within the elevator shafts. Moreover, advantageously, embodiments provided herein can improve elevator system installation efficiency by combining two typically separate components into a single element that can be installed in a single operation. Further, advantageously, by incorporating the light elements into the guards, maintenance on the light elements may be made easier by requiring less work and/or not requiring a mechanic to enter the elevator shaft to perform such maintenance.

Those of skill in the art will appreciate that various example embodiments are shown and described herein, each having certain features in the particular embodiments, but the present disclosure is not thus limited. That is, features of the various embodiments can be exchanged, altered, or otherwise combined in different combinations without departing from the scope of the present disclosure.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments.

Accordingly, the present disclosure is not to be seen as limited by the foregoing description, but is only limited by the scope of the appended claims.

1. An elevator system comprising:
an elevator shaft;
a plurality of landings, wherein each landing includes a landing door that enables access from the landing into the elevator shaft;
a plurality of guards arranged within the elevator shaft, wherein each landing door includes one of the plurality of guards proximate thereto; and
a light element integrated into at least one of the plurality of guards and arranged to project light into the elevator shaft.

2. The elevator system of claim 1, wherein the light element is an LED light.

3. The elevator system of claim 1, wherein the light element is an LED light strip.

4. The elevator system of claim 1, wherein the light element is fixedly mounted to the guard.

5. The elevator system of claim 1, wherein the guard is a toe guard or apron of the elevator system.

6. The elevator system of claim 1, wherein each guard of the plurality of guards includes an integrated light element.

7. The elevator system of claim 1, further comprising:
a switch; and
wiring electrically connecting the light element to the switch, wherein the switch operably controls the light element.

8. The elevator system of claim 7, wherein the plurality of landing doors are located on a front wall of the elevator shaft, and wherein the wiring extends along the front wall of the elevator shaft.

9. The elevator system of claim 1, further comprising an elevator controller, wherein the light element is operably connected to the elevator controller.
